(19) United States
(12) Patent Application Publication
(10) Pub. No.: US 2025/0103456 A1
(43) Pub. Date: Mar. 27, 2025

(54) APPARATUS AND METHOD FOR VERIFYING PERFORMANCE IN COMBINING VIRTUAL COMPONENTS

(71) Applicant: HYUNDAI MOBIS CO., LTD., Seoul (KR)

(72) Inventors: Seong Sik YOO, Yongin-si, Gyeonggi-do (KR); Kwi Hyun KANG, Yongin-si, Gyeonggi-do (KR)

(73) Assignee: HYUNDAI MOBIS CO., LTD., Seoul (KR)

(21) Appl. No.: 18/437,550

(22) Filed: Feb. 9, 2024

(30) Foreign Application Priority Data
Sep. 25, 2023 (KR) 10-2023-0128249

(51) Int. Cl. G06F 11/34; G06F 11/30

(52) U.S. Cl. CPC G06F 11/3409; G06F 11/301

(57) ABSTRACT

Disclosed are an apparatus and method for verifying performance in combining virtual components. An apparatus for verifying performance in combining virtual components according to an exemplary embodiment of the present disclosure includes a memory, and a processor connected to the memory, in which the processor determines a degree of completion of the combination model by comparing complex mode indicator function (CMIF) data of a combination model, which is made by virtually combining a plurality of components, with a preset guideline.

### CROSS-REFERENCE TO RELATED APPLICATION

This application claims priority from and the benefit of Korean Patent Application No. 10-2023-0128249, filed on Sep. 25, 2023, which is hereby incorporated by reference for all purposes as if set forth herein.

### BACKGROUND

### Field

Exemplary embodiments of the present disclosure relate to an apparatus and method for verifying performance in combining virtual components, and more particularly, to an apparatus and method for verifying performance in combining virtual components, which are capable of verifying in advance a degree of completion of a combination model created by virtually combining two or more vehicle components.

### Discussion of the Background

In general, dynamic sub-structuring (DS) and FRF-based sub-structuring (FBS) are technologies used to predict noise and vibration problems that may occur at the time of combining dynamic systems. The DS and FBS may virtually assemble constituent elements provided at different physical positions. Of course, the technology is not required if two or more components may be easily and physically (actually) assembled. The technology is used mostly in situations in which the components are not easy to combine.

However, even in case that a combination model is configured, there is no criterion, tool, or system to intuitively determine accuracy of the combination model for each frequency, combination position, or degree of freedom.

As a current method of determining the accuracy and the degree of completion of the virtual component combination model, there is a method of plotting, in a graph, a difference between a noise prediction value and a vibration prediction value of the virtually combined model and an actual noise value and an actual vibration value of an actually combined finished product and identifying the graph visually.

However, a method of determining a degree of completion of a virtual component combination model in the related art has a drawback in that in order to obtain comparison data for verifying the degree of completion, two or more types of components need to be actually combined, many sensors, measuring instruments, evaluation devices, and the like required to evaluate the degree of completion need to be prepared, and the time and labor are required for direct evaluation.

The background technology of the present disclosure is disclosed in Korean Patent No. 10-1965649 (published on Apr. 10, 2019, and entitled ‘Method of Analyzing Torsion of Vehicle Body Component Module).

### SUMMARY

Various embodiments are directed to an apparatus and method for verifying performance in combining virtual components, which are capable of verifying in advance a degree of completion of a combination model created by virtually combining two or more vehicle components.

In an embodiment, an apparatus for verifying performance in combining virtual components includes: a memory; and a processor connected to the memory, in which the processor determines a degree of completion of the combination model by comparing complex mode indicator function (CMIF) data of a combination model, which is made by virtually combining a plurality of components, with a preset guideline.

According to the present disclosure, the processor may create the combination model by using at least one of FRF-based sub-structuring (FBS), dynamic sub-structuring (DS), and a blocked force.

According to the present disclosure, the processor may compare the CMIF data of the combination model with the guideline and determine whether the CMIF data of the combination model satisfy a completion degree determination condition, the processor may determine that the combination model achieves the degree of completion when the completion degree determination condition is satisfied, and the processor may determine that the combination model does not achieve the degree of completion when the completion degree determination condition is not satisfied.

According to the present disclosure, the guideline may include a CMIF upper limit value and a CMIF lower limit value for each frequency set by a user, the completion degree determination condition may include a first condition in which a peak value of the CMIF data of the combination model is present within a range equal to or larger than the CMIF upper limit value for each frequency, and a second condition in which the CMIF data of the combination model are not present within a range equal to or smaller than the CMIF lower limit value for each frequency, the processor may determine that the combination model achieves the degree of completion when the CMIF data of the combination model satisfy both the first and second conditions, and the processor may determine that the combination model does not achieve the degree of completion when the CMIF data of the combination model do not satisfy at least one of the first and second conditions.

According to the present disclosure, the guideline may include a CMIF first mode result of an actual combination component, and a CMIF final mode result of the actual combination component, the completion degree determination condition may include a first condition in which a peak value of the CMIF data of the combination model is present within a range equal to or larger than the CMIF first mode result of the actual combination component, and a second condition in which the CMIF data of the combination model are not present within a range equal to or smaller than the CMIF final mode result of the actual combination component, the processor may determine that the combination model achieves the degree of completion when the CMIF data of the combination model satisfy both the first and second conditions, and the processor may determine that the combination model does not achieve the degree of completion when the CMIF data of the combination model do not satisfy at least one of the first and second conditions.

According to the present disclosure, the processor may calculate a degree of correlation by comparing an FRF response magnitude for each degree of freedom of each combination part of the combination model with the guideline and create a performance verification map by using the degree of correlation.

According to the present disclosure, the performance verification map may indicate the degree of correlation for each frequency, each combination point, and each of six degrees of freedom, and the degree of correlation may be indicated by a value and a color.

In another embodiment, a method of verifying performance in combining virtual components includes: acquiring, by a processor, complex mode indicator function (CMIF) data of a combination model created by virtually combining a plurality of components; and determining, by the processor, a degree of completion of the combination model by comparing the CMIF data with a preset guideline.

According to the present disclosure, in the determining of the degree of completion of the combination model, the processor may compare the CMIF data of the combination model with the guideline and determine whether the CMIF data of the combination model satisfy a completion degree determination condition, the processor may determine that the combination model achieves the degree of completion when the completion degree determination condition is satisfied, and the processor may determine that the combination model does not achieve the degree of completion when the completion degree determination condition is not satisfied.

According to the present disclosure, the method may further include: after the determining of the degree of completion of the combination model, calculating, by the processor, the degree of correlation by comparing an FRF response magnitude for each degree of freedom of each combination part of the combination model with the guideline and creating a performance verification map by using the degree of correlation.

According to the present disclosure, it is possible to verify in advance the degree of completion of the combination model created by virtually combining the two or more vehicle components.

In addition, the present disclosure provides the part, which has a decreased degree of completion of the combination model and thus needs to be improved, for each frequency band, each combination point position, and each degree of freedom (6-DoF), thereby easily recognizing the improvement point.

In addition, according to the present disclosure, the virtual components are combined by using the DS, the FBS, and the like, the subjective judgment of the engineer is not involved, such that no deviation for each person occurs.

In addition, according to the present disclosure, the degree of completion of the combination model is determined by comparing the CMIF data of the combination model with the guideline, thereby reducing the amount of time required to analyze the combination model.

In addition, according to the present disclosure, the apparatus for verifying performance in combining virtual components is used in the form of a toolbox, such that the degree of completion of the combination model may be easily inspected.

Meanwhile, the effects of the present disclosure are not limited to the above-mentioned effects, and various effects may be included within a range obvious to those skilled in the art from the following description.

### BRIEF DESCRIPTION OF THE DRAWINGS

FIG. 1 is a block diagram schematically illustrating an apparatus for verifying performance in combining virtual components according to an embodiment of the present disclosure.

FIGS. 2A and 2B are exemplified views for explaining a method of determining a degree of completion of a combination model by using a guideline set by a user according to the embodiment of the present disclosure.

FIGS. 3A and 3B are exemplified views for explaining a method of determining a degree of completion of a combination model by using evaluation result data made by actual component combination according to the embodiment of the present disclosure.

FIGS. 4A and 4B are exemplified views for explaining a performance verification map according to the embodiment of the present disclosure.

FIG. 5 is a flowchart for explaining a method of verifying performance in combining virtual components according to the embodiment of the present disclosure.

### DETAILED DESCRIPTION OF THE ILLUSTRATED EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an apparatus and method for verifying performance in combining virtual components will be described below with reference to the accompanying drawings through various exemplary embodiments. Here, thicknesses of lines illustrated in the drawings, sizes of constituent elements, or the like may be exaggerated for clarity and convenience of description. In addition, the terms used below are defined in consideration of the functions thereof in the present disclosure and may vary depending on the intention of a user or an operator or a usual practice. Therefore, such terms should be defined based on the entire contents of the present specification.

For example, the configurations described in the present specification may be implemented as methods or processes, devices, software programs, data stream, or signals. Even though the implementation of the single form is described (e.g., only the method is described), the described features may also be implemented in other forms (e.g., devices or programs). The device may be implemented as appropriate hardware, software, firmware, and the like. For example, the method may be implemented by devices such as processors that generally refer to processing devices including computers, microprocessors, integrated circuits, programmable logic devices, or the like. The processors also include communication devices such as computers, cellular phones, portable/personal information terminals (personal digital assistants (PDA)), and other devices that facilitates information communication with final users.

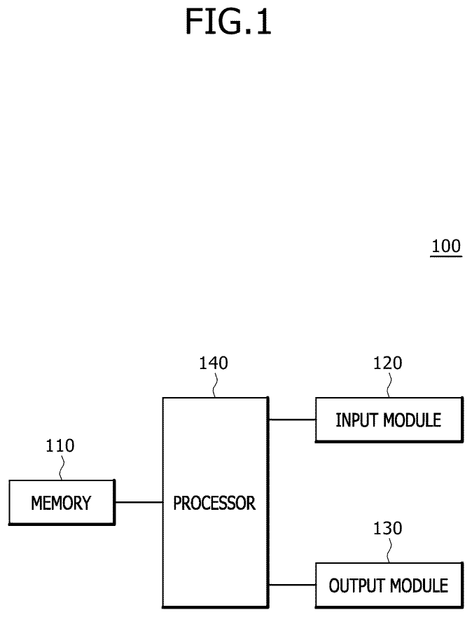

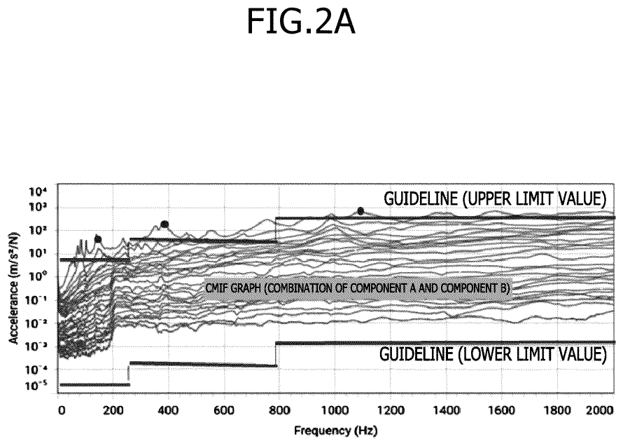

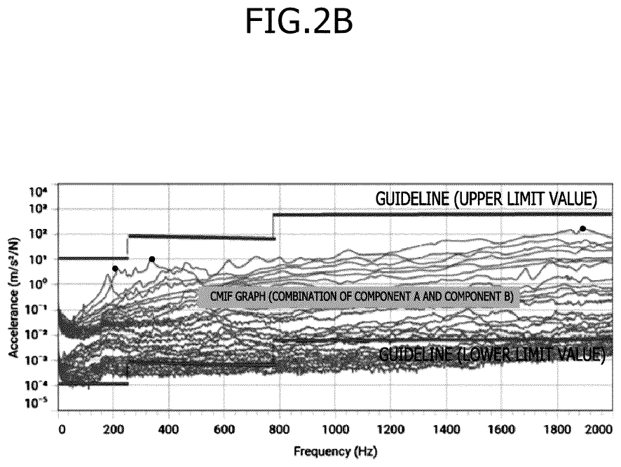

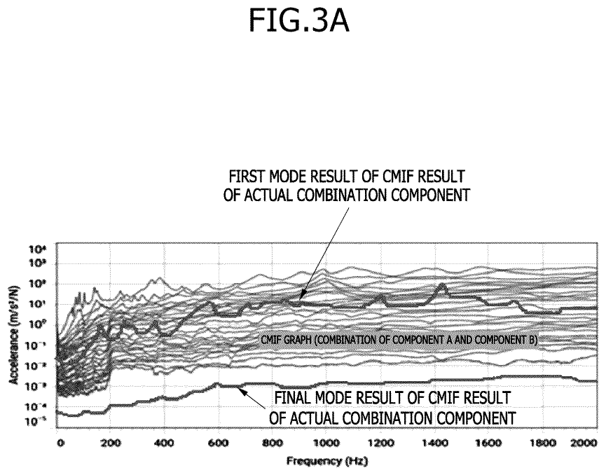

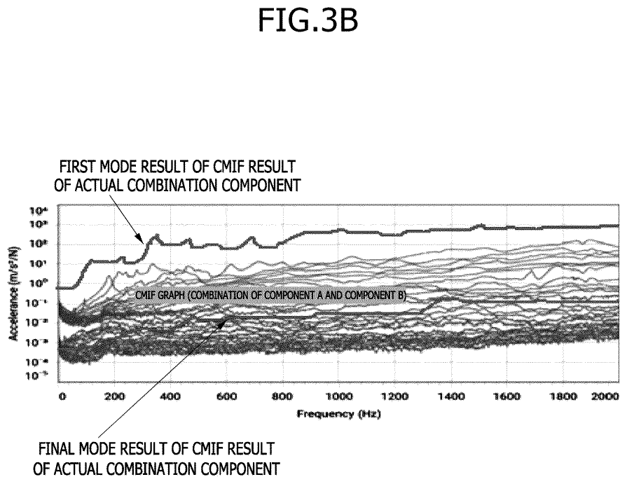

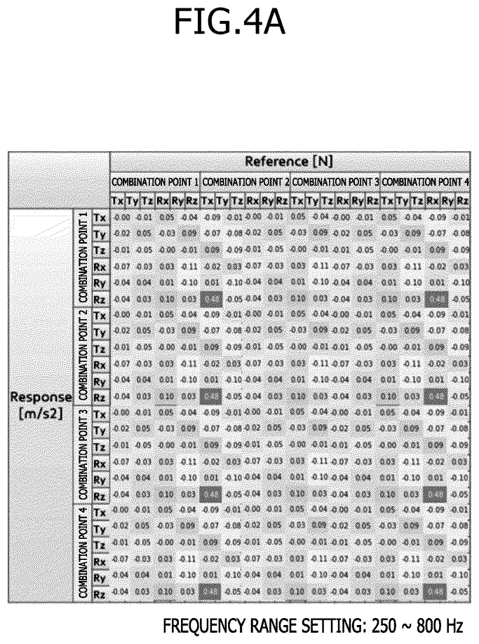

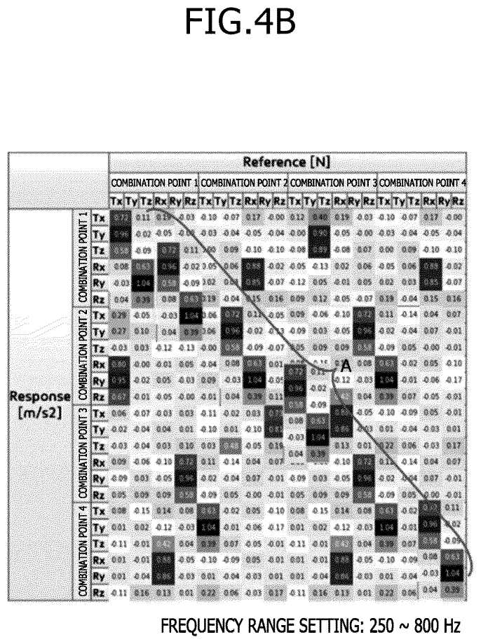

FIG. 1 is a block diagram schematically illustrating an apparatus for verifying performance in combining virtual components according to an embodiment of the present disclosure, FIGS. 2A and 2B are exemplified views for explaining a method of determining a degree of completion of a combination model by using a guideline set by a user according to the embodiment of the present disclosure, FIGS. 3A and 3B are exemplified views for explaining a method of determining a degree of completion of a combination model by using evaluation result data made by actual component combination according to the embodiment of the present disclosure, and FIGS. 4A and 4B are exemplified views for explaining a performance verification map according to the embodiment of the present disclosure.

With reference to FIG. 1, an apparatus 100 for verifying performance in combining virtual components according to an embodiment of the present disclosure includes a memory 110, an input module 120, an output module 130, and a processor 140.

The memory 110 is configured to store data related to an operation of the apparatus 100 for verifying performance in combining virtual components. In this case, a publicly-known storage medium may be used as the memory 110. For example, any one or more of publicly-known storage media such as ROMs, PROMs, EPROMS, EEPROMs, and RAMs may be used. In particular, the memory 110 may store a program (application or applet) capable of creating a combination model by virtually combining a plurality of components, a program (application or applet) capable of determining a degree of completion of the combination model by using CMIF data of the combination model, and a program (application or applet) capable of creating a performance verification map related to combination parts of the combination model. The pieces of stored information may be selected by the processor 140, as necessary.

The input module 120 may receive an input for controlling the apparatus 100 for verifying performance in combining virtual components. The input module 120 may detect a guideline input for determining the degree of completion of the combination model. For example, the input module 120 may receive a CMIF upper limit value and a CMIF lower limit value in respect to frequencies and six degrees of freedom.

The output module 130 is configured to display various pieces of information related to an operation of the apparatus 100 for verifying performance in combining virtual components. In particular, the output module 130 may display a performance verification map and whether the degree of completion of the combination model is achieved when a virtual component combination performance verification program (application) is executed.

The output module 130 may also operate as the input module 120 for receiving information from a user. For example, the output module 130 may be configured as any one of various types of devices such as a touch screen, a display, a hologram device, and a projector.

The processor 140 may be configured to control the overall operation of the apparatus 100 for verifying performance in combining virtual components and configured as an integrated circuit, a system-on chip, or a mobile AP.

The processor 140 may control an overall operating state of the apparatus 100 for verifying performance in combining virtual components. The processor 140 may refer to a data processing device embedded in hardware and having, for example, a circuit physically structured to perform a function represented by codes or instructions included in a program. Examples of the data processing device embedded in hardware may include processing devices such as a microprocessor, a central processing unit (CPU), a processor core, a multiprocessor, an application-specific integrated circuit (ASIC), or a field programmable gate array (FPGA), but the scope of the present disclosure is not limited thereto.

The processor 140 may determine the degree of completion of the combination model by comparing complex mode indicator function (CMIF) data of the combination model, which is created by virtually combining the plurality of components, with the preset guideline and create the performance verification map as the degree of completion of the combination model.

Hereinafter, an operation of the processor 140 will be specifically described.

The processor 140 may create the combination model by virtually combining the plurality of components. In this case, the processor 140 may create the combination model by virtually combining the plurality of components by using FRF-based sub-structuring (FBS), dynamic sub-structuring (DS), a blocked force, and the like. In this case, the FBS may be a technology for combining multiple components in a frequency domain by ensuring an FRF matrix of points at which the components are intended to be combined for each unit. The DS may be a technology for modeling dynamics of a machine system by means of constituent elements or lower structures. The blocked force may be a technology for converting in-operation vibration, which is generated from a source, into a force at a combination point.

When the combination model is created, the processor 140 may obtain complex mode indicator function (CMIF) data of the combination model. The CMIF data may be data created based on singular value decomposition (SVD) of the FRF function in order to identify all the modes of the combination model. That is, the CMIF data may be a graph that identifies magnitudes for frequencies of all the modes of the combination model and lists the modes sequentially from one having the greatest influence.

When the CMIF data of the combination model are acquired, the processor 140 may compare the CMIF data of the combination model with the preset guideline and determine the degree of completion of the combination model. In this case, the guideline may include a CMIF upper limit value and a CMIF lower limit value for each frequency set by the user. In addition, the guideline may be evaluation result data (CMIF data) of the actual combination component. The degree of completion of the combination model indicates how well the components are combined. The degree of completion may be achieved when the components are combined well, and the degree of completion may not be achieved when the components are incorrectly combined.

The processor 140 may compare the CMIF data of the combination model with the guideline and determine whether the CMIF data of the combination model satisfy a completion degree determination condition. In this case, the completion degree determination condition may include a first condition in which a peak value of the CMIF data of the combination model is present within a range equal to or larger than the CMIF upper limit value for each frequency set by the user (or a CMIF first mode result of the actual combination component), and a second condition in which CMIF data of the combination model are not present within a range equal to or smaller than the CMIF lower limit value for each frequency set by the user (or a CMIF final mode result of the actual combination component).

Therefore, the processor 140 may determine that the combination model achieves the degree of completion in case that the CMIF data of the combination model may satisfy both the first and second conditions. In addition, the processor 140 may determine that the combination model does not achieve the degree of completion in case that the CMIF data of the combination model do not satisfy the first condition or the second condition.

For example, a method of determining the degree of completion of the combination model by using the guideline set by the user will be described with reference to FIG. 2.

FIG. 2A illustrates that the degree of completion of the combination model is achieved. In this case, a peak of a CMIF graph of a combination model made by virtually combining component A and component B is present within the range equal to or larger than the CMIF upper limit value for each frequency, and CMIF data of the CMIF graph of the combination model made by virtually combining component A and component B are not present within the range equal to or smaller than the CMIF lower limit value for each frequency. Therefore, the processor 140 may determine that the combination model, which is made by virtually combining component A and component B, achieves the degree of completion.

FIG. 2B illustrates that the degree of completion of the combination model is not achieved. In this case, the peak of the CMIF graph of the combination model made by virtually combining component A and component B is not present within the range equal to or larger than the CMIF upper limit value for each frequency, and the CMIF data of the CMIF graph of the combination model made by virtually combining component A and component B are present within the range equal to or smaller than the CMIF lower limit value for each frequency. Therefore, the processor 140 may determine that the combination model, which is made by virtually combining component A and component B, does not achieve the degree of completion.

Next, a method of determining the degree of completion of the combination model in case that the evaluation result data made by the actual component combination is set to the guideline will be described with reference to FIG. 3. FIG. 3A illustrates that the degree of completion of the combination model is achieved. In this case, the peak of the CMIF graph of the combination model made by virtually combining component A and component B is present within the range equal to or larger than the CMIF first mode result of the actual combination component, and the CMIF data of the CMIF graph of the combination model made by virtually combining component A and component B are not present within the range equal to or smaller than the CMIF final mode result of the actual combination component. Therefore, the processor 140 may determine that the combination model, which is made by virtually combining component A and component B, achieves the degree of completion.

FIG. 3B illustrates that the degree of completion of the combination model is not achieved. In this case, the peak of the CMIF graph of the combination model made by virtually combining component A and component B is not present within the range equal to or larger than the CMIF first mode result of the actual combination component, and the CMIF data of the CMIF graph of the combination model made by virtually combining component A and component B are present within the range equal to or smaller than the CMIF final mode result of the actual combination component. Therefore, the processor 140 may determine that the combination model, which is made by virtually combining component A and component B, does not achieve the degree of completion.

When it is determined whether the degree of completion of the combination model is achieved, the processor 140 may calculate a degree of correlation by comparing an FRF response magnitude for each degree of freedom of each of the combination parts of the combination model with the guideline and create the performance verification map by using the degree of correlation. In this case, the processor 140 may calculate a difference between the CMIF upper limit value set to the guideline (or the CMIF first mode result of the actual combination component) and the FRF response magnitude for each degree of freedom of each of the combination parts and calculate the degree of correlation on the basis of the calculated difference. Thereafter, the processor 140 may create the performance verification map indicating the degree of correlation for each frequency, each combination point, and each of six degrees of freedom and output the degree of correlation through the output module 130. In this case, the processor 140 may change colors depending on the degrees of correlation. Therefore, the processor 140 may display the degrees of correlation by colors and values in the performance verification map.

For example, as illustrated in FIG. 4, the processor 140 may create the performance verification map.

FIG. 4A illustrates the performance verification map in case that the degree of completion of the combination model is achieved. The performance verification map may indicate the degrees of correlation according to the six degrees of freedom at combination point 1, combination point 2, combination point 3, and combination point 4 within a frequency range (250 to 800). In this case, the degrees of correlation are indicated by similar colors, which may indicate that combination point 1, combination point 2, combination point 3, and combination point 4 are combined well within the frequency range (250 to 800).

FIG. 4B illustrates the performance verification map in case that the degree of completion of the combination model is not achieved. The performance verification map may indicate the degrees of correlation according to the six degrees of freedom at combination point 1, combination point 2, combination point 3, and combination point 4 within the frequency range (250 to 800). In this case, a degree of correlation in region A is indicated by a color darker than that of the degrees of correlation of the other regions, and the region A may indicate that combination point 1, combination point 2,combination point 3, and combination point 4 are not combined well within the frequency range (250 to 800).

The processor 140 may compare the FRF response magnitude for each degree of freedom with reference FRF data and output the correlation, thereby providing the combination part required to be improved for each frequency band, each combination point position, and each degree of freedom (6-DoF).

The entirety or at least a part of the configuration of the apparatus 100 for verifying performance in combining virtual components, which is configured as described above, may be implemented in the form of a hardware module or a software module or implemented in the form of a combination of a hardware module and a software module. In this case, the software module may be understood as an instruction executed by the processor 140 that performs computation in the apparatus 100 for verifying performance in combining virtual components. The instruction may have a form mounted in the memory 110 in the apparatus 100 for verifying performance in combining virtual components.

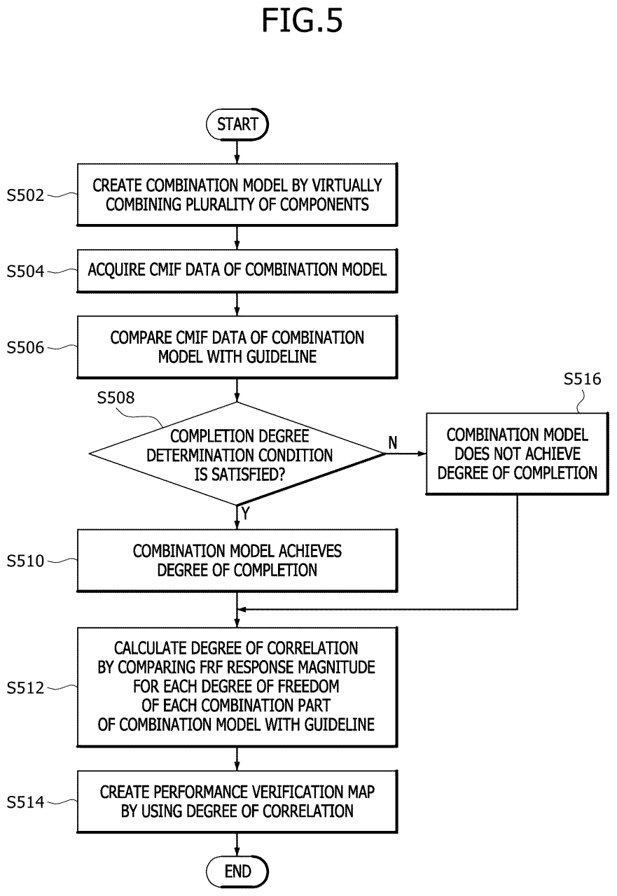

FIG. 5 is a flowchart for explaining a method of verifying performance in combining virtual components according to the embodiment of the present disclosure.

With reference to FIG. 5, the processor 140 creates the combination model by virtually combining a plurality of components (S502). In this case, the processor 140 may create the combination model by virtually combining the plurality of components by using FRF-based sub-structuring (FBS), dynamic sub-structuring (DS), a blocked force, and the like.

When step S502 is performed, the processor 140 acquires the CMIF data of the combination model (S504). The CMIF data may be data created based on singular value decomposition (SVD) of the FRF function in order to identify all the modes of the combination model.

When step S504 is performed, the processor 140 compares the CMIF data of the combination model with the preset guideline (S506) and determines whether the CMIF data of the combination model satisfy the completion degree determination condition (S508). In this case, the completion degree determination condition may include the first condition in which the peak value of the CMIF data of the combination model is present within the range equal to or larger than the CMIF upper limit value for each frequency set by the user (or the CMIF first mode result of the actual combination component), and the second condition in which the CMIF data of the combination model are not present within the range equal to or smaller than the CMIF lower limit value for each frequency set by the user (or the CMIF final mode result of the actual combination component).

Therefore, the processor 140 may determine that the combination model achieves the degree of completion in case that the CMIF data of the combination model may satisfy the first and second conditions. In addition, the processor 140 may determine that the combination model does not achieve the degree of completion in case that the CMIF data of the combination model do not satisfy the first condition or the second condition.

When the determination result in step S508 indicates that when the CMIF data of the combination model satisfy the completion degree determination condition, the processor 140 determines that the combination model achieves the degree of completion (S510).

When step S510 is performed, the processor 140 calculates the degree of correlation by comparing the FRF response magnitude for each degree of freedom of each of the combination parts of the combination model with the guideline (S512) and creates the performance verification map by using the calculated degree of correlation (S514). In this case, the processor 140 may calculate the degree of correlation on the basis of the difference between the CMIF upper limit value for each frequency set to the guideline (or the CMIF first mode result of the actual combination component) and the FRF response magnitude for each degree of freedom of each of the combination parts. Thereafter, the processor 140 may create the performance verification map indicating the degree of correlation for each frequency, each combination point, and each of six degrees of freedom and output the created performance verification map through the output module 130. In this case, the processor 140 may change colors depending on the degrees of correlation. Therefore, the processor 140 may display the degrees of correlation by colors and values in the performance verification map.

When the determination result in step S508 indicates that when the CMIF data of the combination model do not satisfy the completion degree determination condition, the processor 140 determines that the combination model does not achieve the degree of completion S516 and performs step S512.

As described above, according to the present disclosure, it is possible to verify in advance the degree of completion of the combination model created by virtually combining the two or more vehicle components.

In addition, the present disclosure provides the part, which has a decreased degree of completion of the combination model and thus needs to be improved, for each frequency band, each combination point position, and each degree of freedom (6-DoF), thereby easily recognizing the improvement point.

In addition, according to the present disclosure, because the virtual components are combined by using the DS, the FBS, and the like, the subjective judgment of the engineer is not involved, such that no deviation for each person occurs.

In addition, according to the present disclosure, the degree of completion of the combination model is determined by comparing the CMIF data of the combination model with the guideline, thereby reducing time required to analyze the combination model.

In addition, according to the present disclosure, the apparatus for verifying performance in combining virtual components is used in the form of a toolbox, such that the degree of completion of the combination model may be easily inspected.

While the present disclosure has been described with reference to the embodiment illustrated in the drawings, the embodiment is only for illustrative purpose, and those skilled in the art to which the present technology pertains will understand that various modifications of the embodiment and any other embodiment equivalent thereto are available. Accordingly, the true technical protection scope of the present disclosure should be determined by the appended claims.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An apparatus for verifying performance in combining virtual components, the apparatus comprising:
a processor; and
a memory storing instructions which when executed by the processor cause the processor to: determine a degree of completion of a combination model by comparing complex mode indicator function (CMIF) data of the combination model, which is made by virtually combining a plurality of components, with a preset guideline.

2. The apparatus of claim 1, wherein the memory stores instructions which when executed by the processor further cause the processor to create the combination model by using at least one of frequency response function-based (FRF-based) sub-structuring (FBS), dynamic sub-structuring (DS), and a blocked force.

3. The apparatus of claim 1, wherein the memory stores instructions which when executed by the processor further cause the processor to:
compare the CMIF data of the combination model with the preset guideline and determine whether the CMIF data of the combination model satisfy a completion degree determination condition,
determine that the combination model achieves the degree of completion when the completion degree determination condition is satisfied, and
determine that the combination model does not achieve the degree of completion when the completion degree determination condition is not satisfied.

4. The apparatus of claim 3, wherein the guideline comprises a CMIF upper limit value and a CMIF lower limit value for each frequency set by a user,
wherein the completion degree determination condition comprises a first condition in which a peak value of the CMIF data of the combination model is present within a range equal to or larger than the CMIF upper limit value for each frequency, and a second condition in which the CMIF data of the combination model are not present within a range equal to or smaller than the CMIF lower limit value for each frequency, and
wherein the memory stores instructions which when executed by the processor further cause the processor to determine that the combination model achieves the degree of completion when the CMIF data of the combination model satisfy both the first and second conditions, and determine that the combination model does not achieve the degree of completion when the CMIF data of the combination model do not satisfy at least one of the first and second conditions.

5. The apparatus of claim 3, wherein the preset guideline comprises a CMIF first mode result of an actual combination component, and a CMIF final mode result of the actual combination component,
wherein the completion degree determination condition comprises a first condition in which a peak value of the CMIF data of the combination model is present within a range equal to or larger than the CMIF first mode result of the actual combination component, and a second condition in which the CMIF data of the combination model are not present within a range equal to or smaller than the CMIF final mode result of the actual combination component, and
wherein the memory stores instructions which when executed by the processor further cause the processor to determine that the combination model achieves the degree of completion when the CMIF data of the combination model satisfy both the first and second conditions, and determine that the combination model does not achieve the degree of completion when the CMIF data of the combination model do not satisfy at least one of the first and second conditions.

6. The apparatus of claim 1, wherein the memory stores instructions which when executed by the processor further cause the processor to calculate a degree of correlation by comparing an FRF response magnitude for each degree of freedom of each combination part of the combination model with the preset guideline and create a performance verification map by using the degree of correlation.

7. The apparatus of claim 6, wherein the performance verification map indicates the degree of correlation for each frequency, each combination point, and each of six degrees of freedom, and the degree of correlation is indicated by a value and a color.

8. A method of verifying performance in combining virtual components, the method comprising:
acquiring, by a processor, complex mode indicator function (CMIF) data of a combination model created by virtually combining a plurality of components; and
determining, by the processor, a degree of completion of the combination model by comparing the CMIF data with a preset guideline.

9. The method of claim 8, wherein the determining of the degree of completion of the combination model comprises:
comparing, by the processor, the CMIF data of the combination model with the guideline and determines whether the CMIF data of the combination model satisfy a completion degree determination condition,
determining, by the processor, that the combination model achieves the degree of completion when the completion degree determination condition is satisfied, and
determining, by the processor, that the combination model does not achieve the degree of completion when the completion degree determination condition is not satisfied.

10. The method of claim 8, further comprising:
after the determining of the degree of completion of the combination model, calculating, by the processor, the degree of correlation by comparing a frequency response function (FRF) response magnitude for each degree of freedom of each combination part of the combination model with the preset guideline and creating a performance verification map by using the degree of correlation.
